(19) United States
(12) Patent Application Publication
(10) Pub. No.: US 2024/0151668 A1
(43) Pub. Date: May 9, 2024

(54) Device and Method for Determining Dewpoint or Humidity

(71) Applicant: Matrix Sensors, Inc., San Diego, CA (US)

(72) Inventors: Paul R Wilkinson, El Segundo, CA (US); Thomas D Carr, Encinitas, CA (US)

(73) Assignee: Matrix Sensors, Inc., San Diego, CA (US)

(21) Appl. No.: 18/387,847

(22) Filed: Nov. 7, 2023

Related U.S. Application Data
(60) Provisional application No. 63/423,495, filed on Nov. 7, 2022.

(51) Int. Cl. G01N 25/68

(52) U.S. Cl. CPC G01N 25/68

(57) ABSTRACT

A device for measuring dew point or humidity comprises a single resonator and at least one temperature-regulating element arranged to control the temperature of the resonator by heating and/or cooling. Frequency measuring circuitry is arranged to generate signals indicative of measured frequencies of the resonator. At least one controller or processor receives the signals and determines the temperature of the resonator at which condensation (e.g., dew, frost, or condensed vapor) appears on the resonator or evaporates from the resonator according to the signals.

### CROSS REFERENCE TO RELATED APPLICATIONS

This application claims the benefit of U.S. provisional patent application 63/423,495 filed on Nov. 7, 2022 which application is hereby incorporated by reference in its entirety.

### BACKGROUND

The invention relates generally to hygrometers, and in particular to a device and method for measuring dew point or humidity of an environment.

Dew point meters and/or humidity sensors are important for many applications either as a stand-alone device or as a component around which to build a humidity-regulating apparatus. Capacitive sensors for relative humidity (RH) are known to drift when operating at low humidity, and are limited to an accuracy of 1.5% RH for consumer devices. Additionally, capacitive humidity sensors are prone to hysteresis due to their use of an absorbent material to adsorb moisture. Chilled mirror hygrometers also exist to measure dew point or humidity. However, chilled mirror hygrometers require expensive and easily fouled optical components, and a separate temperature sensor such as a platinum resistance thermometer.

Some humidity sensors in the prior art require at least two resonators, and a separate temperature sensor. The dual resonator approach nulls the effect of temperature on the condensation detector, but then requires an additional temperature sensor. Since these devices rely on a dynamically changing temperature, device engineering is much more complicated if one must ensure multiple, proximal (but not co-located) sensing elements such as resonators, thermistors or the like.

Other humidity sensors in the prior art require sensing material that adsorbs moisture to enable a gravimetric change that is roughly proportional to humidity. Frequency is used to quantify humidity based on the mass (gravimetric) of water absorbed into the sensing layer that is in equilibrium with the atmospheric water (e.g., 2× higher RH→2× higher water absorbed by the absorbing layer). These devices are subject to gravimetric drift. In some devices, mass and temperature are detected separately using either a conventional temperature sensor such as a thermistor, and/or a control resonator that partially subtracts the effects of temperature on the mass measurement. Resonators are known to age at differing and unpredictable rates, so the temperature-corrected mass measurement is expected to worsen over time.

There is still a need for a simple, low cost device to measure dew point or humidity with accuracy greater than commonplace capacitive humidity sensors (typical accuracy >1.5%) that also overcomes the disadvantages of chilled mirror hygrometers.

### SUMMARY

According to an aspect, a device for measuring dew point or humidity comprises a single resonator and at least one temperature-regulating element arranged to control the temperature of the resonator by heating and/or cooling. The device also comprises frequency-measuring circuitry arranged to measure at least one frequency of the resonator and to generate signals indicative of the frequency. At least one controller or processor is arranged to receive the signals from the frequency measuring circuitry. The processor is programmed to determine the temperature of the resonator at which dew condenses on the resonator or evaporates from the resonator according to the signals.

According to another aspect, a method for measuring dew point or humidity comprises the steps of heating and/or cooling a resonator to a dew point using at least one temperature-regulating element arranged to control the temperature of the resonator. The method also comprises the steps of measuring at least one frequency of the resonator using frequency measuring circuitry and generating signals indicative of the frequency of the resonator. At least one processor or controller is utilized to determine the temperature of the resonator at which dew condenses on or evaporates from the resonator according to the signals.

### BRIEF DESCRIPTION OF THE DRAWINGS

The foregoing aspects and advantages of the present invention will become better understood upon reading the following detailed description and upon reference to the drawings where:

FIG. 1 is a block diagram of a device for measuring dew point or humidity according to a first embodiment.

FIG. 2 is a block diagram of another device for measuring dew point or humidity.

FIG. 3 is a block diagram of a device for measuring dew point or humidity with servo control of a process variable according to another embodiment.

### DETAILED DESCRIPTION OF PREFERRED EMBODIMENTS

In the following description, it is understood that all recited connections between structures can be direct operative connections or indirect operative connections through intermediary structures. An element includes one or more elements. Any recitation of an element is understood to refer to at least one element. A plurality of elements includes at least two elements. Unless otherwise required, any described method steps need not be necessarily performed in a particular illustrated order. A first element (e.g., a signal or data) derived from a second element encompasses a first element equal to the second element, as well as a first element generated by processing the second element and optionally other signals or data. Making a determination or decision according to (or in dependence upon) a parameter encompasses making the determination or decision according to the parameter and optionally according to other signals or data. Unless otherwise specified, an indicator of some quantity/data may be the quantity/data itself, or an indicator different from the quantity/data itself such as a signal from which the quantity/data can be determined.

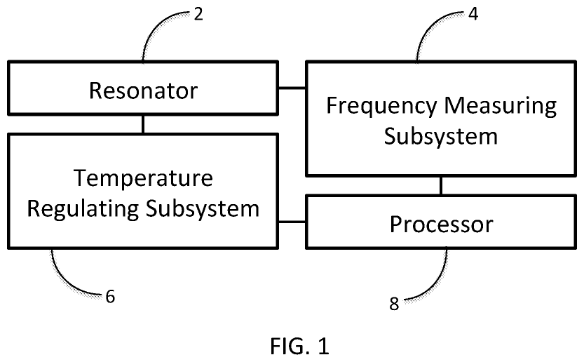

FIG. 1 shows a first example of a device for measuring a dew point or humidity level of an environment or body of air. The device comprises a mechanical resonator 2 having multiple resonant modes. The multiple resonant modes have different sensitivities to the temperature of the resonator 2. In some embodiments, the multiple resonant modes of the resonator 2 may also have differing sensitivity to the presence or absence of liquid or solid matter on a surface of the resonator. The resonator 2 functions simultaneously to detect the creation or evaporation of condensation (e.g., dew, frost, water or condensed organic vapor) on a surface of the resonator 2 and also gives the temperature of the resonator 2 at which condensation is created on the resonator or evaporates from the resonator. The dew point is the temperature at which dew condenses on or evaporates from the resonator.

In some embodiments, the device includes a housing or flow-through enclosure (not shown) to protect the resonator 2 from the environment while still exposing a surface of the resonator 2 to air in the environment. A flow-through enclosure or housing typically includes walls defining a chamber having an inlet and outlet for ambient air to flow through the chamber. The resonator 2 has at least one surface (e.g., the top surface) exposed to air flowing through the chamber. It is also possible to expose at least one surface of the resonator 2 to the ambient environment without a flow-through enclosure, but the device will typically have a housing (not shown for clarity of the patent drawing) for holding and protecting the electronic components. The housing has an opening to expose a surface of the resonator to the ambient air. In either case, a preferred resonator is a quartz disk having a top side with an electrode and a backside with an electrode. Typically, the top side of the quartz disk is exposed to ambient air, with or without a flow-through enclosure, and condensation forms on this top surface of the resonator when it is cooled to the dew point temperature and evaporates if it is heated above the dew point temperature.

Condensation or evaporation of the dew may be detected by a frequency shift (e.g., a change in resonance frequency) of the resonator 2 induced by the mass of the dew or frost that forms on a surface of the resonator or evaporates from the surface. The temperature of the resonator 2 is simultaneously determined from the resonance frequencies of the resonator in the multiple resonant modes having different sensitivities to temperature. In alternative embodiments, condensation or evaporation may be detected by a change in the quality factor of the resonator or by the change in dissipation induced by condensation on or evaporation from the surface of the resonator 2. A suitable resonator 2 may be electromechanical such as a quartz crystal resonator (QCR), quartz crystal microbalance (QCM), surface acoustic wave (SAW) transducer, cantilever, or MEMS resonator. In some embodiments, the resonator may be an optomechanical resonator.

The device also comprises a temperature-regulating subsystem 6 arranged to vary and/or control the temperature of the resonator 2 by heating and/or cooling. Typically the resonator will be cooled to (or near) the temperature at which dew or frost appears on a surface of the resonator. The device further comprises a frequency-measuring subsystem 4 arranged to measure the frequencies (e.g., resonance frequencies) of the resonator 2 in the multiple resonant modes of varying temperature sensitivity. This frequency-measuring subsystem 4 can be composed of multiple pieces, such as a multi-frequency oscillator and a frequency counter.

At least one controller or processor 8 is arranged to receive the frequency measurement signals from the frequency-measuring circuitry 4. The processor 8 converts the measured frequency signals to temperature of the resonator 2 and a secondary parameter such as mass loaded on a surface of the resonator, dissipation, or quality factor (Q-value) that indicates the presence of condensation on a surface of the resonator 2, or evaporation of the dew, frost or condensed vapor from the surface of the resonator. The temperature at which condensation or evaporation of the condensed liquid is detected on a surface of the resonator 2 is reported as the dewpoint value. The processor 8 may optionally convert the dew point value to a related parameter, such as relative humidity or absolute humidity via well-known formulae. Dew point can be directly converted to absolute humidity, and is related to relative humidity by the ambient temperature.

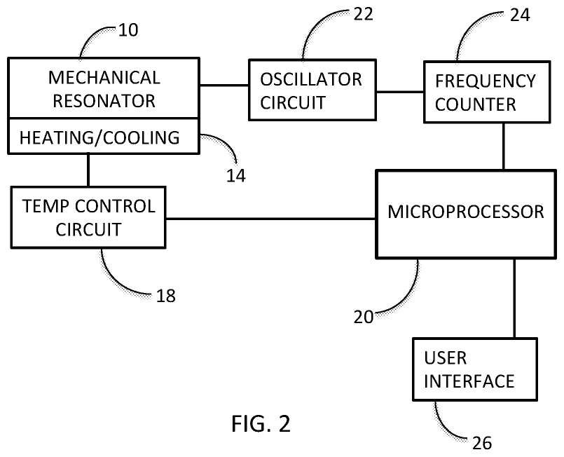

FIG. 2 shows another example of a device used to measure the dewpoint or humidity level of an environment or body of air. The device includes a resonator 10 such as a quartz crystal resonator (QCR), quartz crystal microbalance (QCM), surface acoustic wave (SAW) transducer, cantilever, or MEMS resonator. At least one temperature-regulating element 14 is positioned to heat and/or cool the resonator 10. The resonator 10 may require heating and/or cooling to reach the temperature of the dew point (usually cooling). Typically the resonator 10 will be heated and/or cooled to (or near) the temperature at which dew condenses on or evaporates from a surface of the resonator.

The temperature-regulating element 14 may comprise at least one heater, cooling element, or device that provides both heating and cooling. In some embodiments, the temperature-regulating element is an active cooling element since the resonator 10 usually needs to be cooled to the temperature of the dew point. In other embodiments, the temperature-regulating element is a resistive heater and passive cooling is used. In still other embodiments, the temperature-regulating element provides both active heating and cooling, such as a thermoelectric device (TED) that heats and cools the resonator 10. In general, suitable heating elements include conductive heaters, convection heaters, or radiation heaters. Examples of conductive heaters include resistive or inductive heating elements, e.g., resistors or thermoelectric devices. Convection heaters include forced air heaters or fluid heat-exchangers. Suitable radiation heaters include infrared or microwave heaters. Similarly, various cooling elements may be used to cool the resonator 10. For example, various convection cooling elements may be employed such as a fan, Peltier device, refrigeration device, or jet nozzle for flowing cooling fluids. Alternatively, various conductive cooling elements may be used, such as a heat sink (e.g. a cooled metal block).

It is not necessary to have direct physical contact between the resonator 10 and the temperature-regulating element 14. So long as there is adequate thermal contact between these elements of the device, then heat will be able to exchange between one or more temperature-regulating elements 14 and the resonator 10. A temperature control circuit 18 is connected to the temperature-regulating element 14 and at least one microprocessor 20. The temperature control circuit 18 preferably operates under microprocessor control to heat and/or cool the resonator 10. Alternatively, temperature control may be performed by the microprocessor 20 without a separate temperature control circuit, which is only shown here as a separate element for purposes of illustration. Temperature control and temperature feedback loops are well known in the art, and so are many suitable heating and cooling elements.

The device also includes at least one frequency-measuring circuit (e.g., a readout circuit for a quartz crystal) arranged to detect frequency responses of the resonator 10 in multiple resonance modes as the resonator's temperature is changed and condensation appears on or evaporates from a surface of the resonator 10. The frequency-measuring circuit outputs signals indicative of the measured frequencies of the resonator in the multiple resonant modes. In some embodiments, the frequency-measuring circuit comprises a multi-frequency oscillator circuit 22 that drives the resonator 10 and a frequency counter 24 that measures the frequencies (e.g., resonance frequencies or frequency shifts) in the multiple resonant modes. Many suitable oscillator circuits and frequency counters are known in the art. The oscillator circuit 22 and the frequency counter 24 output the frequency signals to the microprocessor 20.

Other suitable detection methods are known to detect and measure frequencies of a resonator in multiple resonance modes or a single resonance mode. The frequencies of the resonator are often detected using an electrical property, such as a change in impedance of the circuit driving an oscillating motion of the resonator 10. In some embodiments, an optical detector is used to detect frequencies of the resonator 10. The temperature of the resonator 10 and mass loading (from condensation of dew or frost) on the surface of the resonator 10 is detected by monitoring frequency of the resonator, or multiple frequencies from multiple resonance modes, and there are many well known electrical or optical techniques to detect frequency and generate frequency measurement signals.

The microprocessor 20 receives the frequency measurement signals. The microprocessor 20 is programmed to determine the temperature of the resonator 10 at which condensation (e.g., dew, frost or condensed organic vapor) is created on a surface of the resonator 10 or evaporated from the surface of the resonator according to the frequency signals. For example, the temperature of the resonator 10 is usually determined using look-up tables or calibration data stored in memory of the microprocessor 20 that relate temperature of the resonator 10 to the resonance frequencies of the resonator measured at the multiple resonant modes having different sensitivities to the temperature of the resonator 10.

The presence of condensation on a surface of the resonator 10 or evaporation of the condensation is preferably determined by the microprocessor 20 by determining the amount of mass (if any) of condensation that is loaded on the surface of the resonator. For example, the mass loading is usually determined using look-up tables or calibration data or equations stored in memory of the microprocessor 20 that relate mass loaded on the surface of the resonator 10 to measured frequency of the resonator in a single resonance mode or multiple resonant modes. The computed mass may be compared to a threshold value to determine if the condensation is present on the surface of the resonator 10 or if the dew, frost or condensed vapor is evaporating.

In alternative embodiments, the condensation or evaporation of moisture on a surface of the resonator 10 may be determined by the microprocessor 20 by determining either the dissipation (or dissipation factor) or the quality factor (Q-value). The dissipation factor is a measure of loss-rate of energy of a mode of oscillation (mechanical, electrical, or electromechanical). The dissipation factor is typically the reciprocal of the quality factor (Q-value) which represents the “quality” or durability of oscillation. Both of these parameters are affected by condensation or evaporation of moisture on a surface of the resonator 10 so that either one may be used to detect the point in time when dew or moisture condenses or evaporates. The microprocessor 20 calculates dissipation or quality factor from the frequency measurement signals (e.g., using look-up tables or calibration data or equations stored in memory). The computed dissipation or quality factor may be compared to a respective threshold value to determine if the condensation is present on the surface of the resonator 10 or if evaporation of the moisture is occurring. Alternatively, the microprocessor 20 may simply determine if there is a significant change in either the dissipation or quality factors as the resonator is cooled to the dew point temperature or heated, indicating condensation or evaporation of condensed liquid on the surface of the resonator 10.

In a first simple example of operation, the resonator 10 is cooled linearly. As the resonator 10 cools, instantaneous temperature and mass are measured simultaneously (e.g., by calibration data or a look-up table stored in the memory of the microprocessor 20 that relates measured frequencies to resonator temperature and mass loaded on the resonator). When condensation (dew or frost) forms on the surface of the resonator 10, the temperature of the resonator at which condensation began forming (or began evaporating) is recorded as the dewpoint. The dewpoint may be optionally converted to a related parameter, such as relative or absolute humidity via well-known formulae.

A user interface 26 is optionally connected to the processor 20. The user interface 26 preferably includes a display for displaying dew point values or humidity levels, and at least one user-input device for selecting parameter values, such as target values at which an alarm should be initiated.

In some embodiments, the setup and calibration of the device is performed by an empirical calibration of the resonant modes of the resonator 10 to relate measured frequencies to temperature of the resonator. The temperature of the resonator is varied in a controlled, accurate environment, such as an oven that is referenced to a temperature standard. Similarly, a calibration may be performed that relates measured frequencies to the loading (or unloading) of mass on a surface of the resonator 10 indicating the presence (or evaporation) of condensation on a surface of the resonator.

Advantageous aspects of the device are (1) detection of condensation or evaporation via changes to a resonator's mechanical resonance, dissipation or quality factor; and (2) a self-temperature-sensing resonator used to report the temperature at which condensation or evaporation occurs. There are no water absorbers or separate temperature sensors involved. We instead employ a single resonator having multiple resonant modes to measure both mass and temperature, relying primarily on the accuracy of the resonator to detect the onset of condensation or evaporation, as detected by mass loading or dissipation or quality factor. The overall accuracy of the mass or dissipation or quality factor is largely inconsequential, only their ability to detect the creation or evaporation of condensation on a surface of the resonator. The single resonator ensures accurate temperature measurement when the creation or evaporation of condensation on the surface of the resonator is detected.

In another embodiment, the resonator 10 is a single mode version, meaning only one resonant mode is used to determine the creation or evaporation of condensation on the resonator and the resonator's temperature when the condensation is formed (or when the condensation evaporates). The frequency-measuring electronics (e.g., the oscillator circuit 22 and frequency counter 24) are arranged to generate signals sufficient for the processor to determine a resonance frequency of a single resonance mode (e.g., b-mode), as well as dissipation or quality factor. In this single resonant mode version of the device, the processor is programmed to use frequency measurement signals of a single resonant mode (e.g., b-mode) to determine temperature of the resonator 10 and dissipation or quality factor (Q-value) as a detector of condensation or evaporation of moisture from the surface of the resonator.

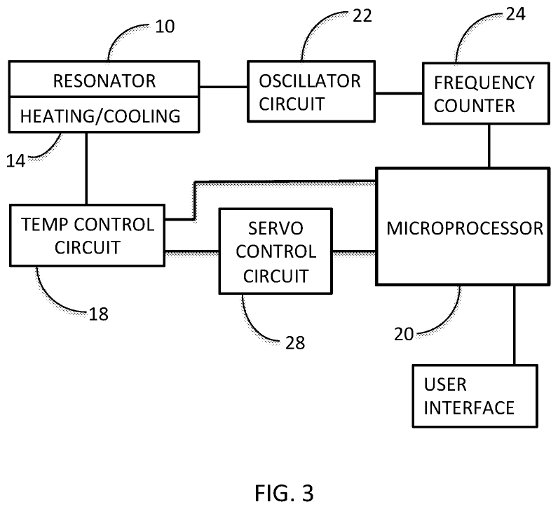

FIG. 3 shows another example of a device used to measure dewpoint and/or humidity level. The device includes the additional feature of a temperature control feedback loop, such as a servo control circuit 28. Many different temperature control feedback loops are known in the art. In an example of operation, the temperature of the resonator 10 is modulated about the dew point with small enough thermal cycles so that dew may both condense and evaporate from a surface of the resonator during one cycle. As before, the dew point is the temperature at which dew condenses or evaporates from a surface of the resonator 10. Preferably, while modulating the temperature of the resonator 10 in alternate heating and cooling cycles around the dew point, the dew point is measured repetitively, so that a semi-continuous reading of dewpoint is achieved, with one or two measurements of dewpoint per thermal cycle.

In another example of operation, the mass of condensation on the resonator 10 is used as a process variable in a control loop, so that the resonator's temperature is regulated to follow the dewpoint so long as the control loop is active. In this way, the device achieves a continuous readout of dewpoint, which may also be converted to relative or absolute humidity by well-known formulae. The temperature control feedback loop (e.g., servo control circuit 28 via phase locked loop) adjusts the temperature of the resonator 10 according to the detected frequency such that the mass of condensation on the resonator 10 is maintained substantially constant around a setpoint mass.

The devices and methods of the present disclosure have several advantages over low-cost humidity sensors (e.g., capacitive humidity sensors): The disclosed device improves on the accuracy of low-cost consumer humidity sensors. Capacitive RH sensors are known to drift when operating at low humidity, and are limited to an accuracy of 1.5% RH for consumer devices. Additionally, capacitive RH sensors are prone to hysteresis. The disclosed system circumvents this issue by eliminating the hysteretic absorbent.

The above description illustrates embodiments of the invention by way of example and not necessarily by way of limitation. Many other embodiments are possible. For example, the device may be a stand-alone instrument or a component of a larger humidity generating or controlling instrument. In some embodiments, the device may be recalibrated by drying it out to compensate for drift in frequency that may result in inaccurate temperature or mass. The device may be used to detect more than just water, e.g., other chemicals or organic vapor.

In some embodiments, the resonator is free of spurious modes across its temperature range (or compensated for spurious modes). Also, the sensor device may optionally include at least one pressure sensor for sensing the ambient or atmospheric pressure. An ambient pressure sensor may be useful for applications of the device in which the ambient or atmospheric pressure may differ from standard atmospheric pressure, and adjustments to the calculation of the dew point and/or humidity may include pressure measurements.

According to some embodiments, the present invention provides, inter alia, computer systems comprising hardware (e.g. one or more processors and associated memory) programmed to perform the methods described herein, as well as computer-readable media encoding instructions to perform the methods described herein. In some embodiments, a look-up table or calibration curve is used to determine the resonator's temperature or mass loaded on a surface of the resonator, according to the signals or data indicating the resonator responses (e.g., frequencies). The look-up table or calibration data may be in one or more processors and associated memory included with the device.

In some embodiments, an on-board microprocessor is programmed to store measured signal values and/or to determine dew point values or humidity values. Alternatively, these functions may be performed in a separate processor or external computer in communication with the sensor portion of the device, with or without wires. Wireless communication between devices is well known in the art. In other embodiments, the sensor has only some signal processing electronics, and some determination and calculation functions are performed in a separate processor or external computer in communication with the resonator electronics and circuits. Alternatively, multiple processors may be provided, e.g., providing one or more signal processing electronics or microprocessors in the device that communicate (wirelessly or with wires) with one or more external processors or computers.

Although a single processor and a single frequency measuring circuit is described in the above embodiments for simplicity in patent drawings, it is to be understood that the device may include multiple processors and/or frequency measuring circuits. In some embodiments, at least one on-board microprocessor or controller receives frequency signals/data from the frequency measuring circuits, either through direct connections or indirectly through one or more additional signal processing circuits or processor components.

Accordingly, the scope of the invention should be determined by the following claims and their legal equivalents.

What is claimed is:

1. A device comprising:
a) a resonator;
b) at least one temperature regulating element arranged to control the temperature of the resonator by heating and/or cooling;
c) frequency measuring circuitry arranged to measure at least one frequency of the resonator and to generate signals indicative of the measured frequency; and
d) at least one processor arranged to receive the signals from the frequency measuring circuitry, wherein the processor is programmed to determine the temperature of the resonator at which condensation appears on the resonator or evaporates from the resonator according to the signals.

2. The device of claim 1, wherein the resonator has multiple resonant modes having different sensitivities to the temperature of the resonator, the frequency measuring circuitry is arranged to measure the resonance frequencies of the resonator at the multiple resonant modes, and the processor is programmed to determine the temperature of the resonator according to the resonance frequencies measured at the multiple resonant modes.

3. The device of claim 1, wherein the processor is programmed to determine the presence of condensation on a surface of the resonator or evaporation of the condensation from frequency signals indicating at least one frequency shift of the resonator induced by mass loading or unloading of the condensation on a surface of the resonator.

4. The device of claim 1, wherein the processor is programmed to convert the signals indicative of the measured frequencies of the resonator to the temperature of the resonator and a secondary parameter that indicates if condensation is formed on the resonator or evaporated from the resonator, and wherein the secondary parameter is either mass of the condensation on the resonator, dissipation of the resonator, or quality factor of the resonator.

5. The device of claim 1, wherein the temperature regulating element is arranged to cool the resonator to a dew point, and the processor is programmed to determine the temperature of the resonator and mass of the condensation on a surface of the resonator substantially simultaneously according to the measured frequencies of the resonator as indicated by the signals.

6. The device of claim 1, wherein the temperature of the resonator at which condensation appears or evaporates is the dew point, and the processor is further programmed to convert the dew point to a relative humidity or absolute humidity value.

7. The device of claim 1, wherein the temperature regulating element is arranged to modulate the temperature of the resonator in thermal cycles around a dew point so that vapor may both condense and evaporate from a surface of the resonator during each thermal cycle, and the processor is programmed to determine the dew point repetitively with one or two measurements of the dew point per thermal cycle.

8. The device of claim 1, wherein the processor is further programmed to determine a mass of the condensation on the resonator according to the signals and to utilize the mass as a process variable in a control loop with the temperature regulating element so that the temperature of the resonator is regulated to follow a dew point and the mass of the condensation on the resonator is maintained substantially constant around a setpoint mass.

9. The device of claim 1, wherein the processor is programmed to determine the temperature of the resonator using frequency signals of a single mode of resonance (e.g., b-mode), and the processor is further programmed to determine the presence of the condensation on the resonator using a quality factor or dissipation of the resonator as an indicator of the condensation on the resonator.

10. A method comprising:
a) heating and/or cooling a resonator to a dew point using at least one temperature regulating element arranged to control the temperature of the resonator;
b) measuring at least one frequency of the resonator using frequency measuring circuitry and generating signals indicative of the frequency of the resonator; and
c) utilizing at least one processor to determine the temperature of the resonator at which condensation is formed on the resonator or evaporates from the resonator according to the signals.

11. The method of claim 10, wherein the resonator has multiple resonant modes having different sensitivities to the temperature of the resonator, the frequency measuring circuitry detects resonance frequencies of the resonator in the multiple resonant modes, the processor determines the temperature of the resonator according to the resonance frequencies of the multiple resonant modes, and the presence of condensation on the resonator is determined by a change in at least one of the resonance frequencies indicative of mass loading of the condensation on a surface of the resonator.

12. The method of claim 10, wherein the processor determines the presence of condensation on the resonator by a change in dissipation or quality factor.

13. The method of claim 10, further comprising the step of utilizing the processor to convert the temperature of the resonator at which condensation appears or evaporates to a relative humidity or absolute humidity value.

14. The method of claim 10, further comprising the steps of modulating the temperature of the resonator in thermal cycles around the dew point so that vapor both condenses and evaporates from a surface of the resonator during each thermal cycle, and determining the temperature of the resonator at least once per thermal cycle when either condensation or evaporation is detected.

15. The method of claim 10, further comprising the steps of determining a mass of the condensation on the resonator according to the signals and utilizing the mass as a process variable in a control loop with the temperature regulating element so that the temperature of the resonator is regulated to follow the dew point while the mass of the condensation on the resonator is maintained substantially constant around a setpoint mass.

16. The method of claim 10, wherein the temperature of the resonator is determined by the processor using frequency signals of a single mode of resonance (e.g., b-mode), and the presence of the condensation on the resonator or evaporation of the condensation is detected using a quality factor or dissipation of the resonator.
